(19) United States
(12) Patent Application Publication
(10) Pub. No.: US 2024/0160896 A1
(43) Pub. Date: May 16, 2024

(54) PROPAGATING ATTENTION INFORMATION IN EFFICIENT MACHINE LEARNING MODELS

(71) Applicant: QUALCOMM Incorporated, San Diego, CA (US)

(72) Inventors: Shashanka VENKATARAMANAN, Amsterdam (NL); Amir GHODRATI, Amsterdam (NL); Amirhossein HABIBIAN, Amsterdam (NL)

(21) Appl. No.: 18/335,685

(22) Filed: Jun. 15, 2023

Related U.S. Application Data
(60) Provisional application No. 63/424,789, filed on Nov. 11, 2022.

(51) Int. Cl. G06N 3/0455

(52) U.S. Cl. CPC G06N 3/0455

(57) ABSTRACT

Certain aspects of the present disclosure provide techniques and apparatus for improved attention-based machine learning. A first attention propagation output is generated using a first transformer block of a plurality of transformer blocks, this generation including processing input data for the first transformer block using a first self-attention sub-block of the first transformer block. The first attention propagation output is propagated to a second transformer block of the plurality of transformer blocks. An output for the second transformer block is generated, this generation including generating output features for the second transformer block based on the first attention propagation output.

### CROSS-REFERENCE TO RELATED APPLICATIONS

This application claims priority to U.S. Provisional Patent Application No. 63/424,789, filed Nov. 11, 2022, the entire contents of which are incorporated herein by reference.

### INTRODUCTION

Aspects of the present disclosure relate to machine learning.

Various machine learning architectures have been used to provide solutions for a wide variety of computational problems. An assortment of machine learning model architectures exist, such as artificial neural networks (which may include convolutional neural networks (CNNs), recurrent neural networks (RNNs), deep neural networks (DNNs), generative adversarial networks (GANs), and the like), random forest models, and the like. Transformer architectures have been applied in natural language processing (NLP) and computer vision. Increasingly, vision transformers have been widely used in a variety of image and video processing tasks.

However, some conventional vision transformers tend to be computationally expensive. For example, because vision transformers generally compute self-attention at every block, the compute and memory demands grow quadratically with respect to the size of the input data. Therefore, despite their accuracy and effectiveness, vision transformers have historically had limited or no applicability to low power (or otherwise constrained) devices. Some conventional solutions fail to provide efficient and accurate transformer architectures.

### BRIEF SUMMARY

Certain aspects provide a method comprising: generating, using a first transformer block of a plurality of transformer blocks, a first attention propagation output, the generating comprising processing input data for the first transformer block using a first self-attention sub-block of the first transformer block; propagating the first attention propagation output to a second transformer block of the plurality of transformer blocks; and generating an output for the second transformer block, the generating the output for the second transformer block comprising generating output features for the second transformer block based on the first attention propagation output.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example architecture for propagation of transformer-generated attention output.

FIGS. 2A and 2B depict example transformer architectures for propagating attention data.

FIGS. 3A and 3B depict example transformer architectures for propagating attention feature data.

FIG. 4 depicts an example encoder/decoder architecture using transformers and attention propagation.

FIG. 5 is a flow diagram depicting an example method for generating and providing attention propagation output.

FIG. 6 is a flow diagram depicting an example method for generating output using propagated attention information.

FIG. 7 is a flow diagram depicting an example method for generating output using propagated feature information.

FIG. 8 is a flow diagram depicting an example method for propagating attention output in transformer architectures.

FIG. 9 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for improved transformer-based models using propagated attention information.

Transformers, and in particular vision transformers, have become increasingly common in a wide variety of machine learning tasks. Transformer-based architectures are generally configured to generate output based on a sequence of data (e.g., a sequence of frames in a video, a sequence of patches from a frame or image, a sequence of words, a sequence of audio data, and the like). Generally, machine learning models may use any number of transformer blocks (each providing self-attention), as well as any other components (e.g., one or more neural network layers).

In some aspects, a transformer comprises a self-attention component to generate self-attention. In some aspects, the transformer may further include a feedforward component (e.g., a small neural network, such as a multilayer perceptron (MLP)). In the self-attention component, the input data may be linearly projected (e.g., multiplied using learned parameters) into three matrices: a query matrix Q (also referred to in some aspects as a query representation or simply “queries”), a key matrix K (also referred to in some aspects as a key representation or simply “keys”), and a value matrix V (also referred to in some aspects as a value representation or simply “values”). For example, during training, one or more query weights, key weights, and value weights are learned based on training data, and the queries Q, keys K, and values V can be generated by multiplying the input data by the learned weights.

In some aspects, an attention matrix A (also referred to as an attention map or simply “attention” in some aspects) is then generated based on the queries and keys. For example, the self-attention block may compute the dot product of the query matrix and the transposed key matrix (e.g., Q K T). In some aspects, the self-attention block can apply one or more operations (e.g., a row-wise softmax operation) to the dot product to yield that attention matrix. That is, the attention matrix may be defined as A=σ(Q·K^{T}), where a is the softmax function.

In some aspects, the features f generated by the self-attention block can then be computed as the dot product of the attention matrix A and the value matrix V. These features can then be provided as input to the feedforward block (e.g., a neural network or subnet) to generate an output from the transformer block.

Such transformer blocks are computationally expensive. For example, the compute and memory of the self-attention component scales quadratically with the size of the input. In conventional architectures, which often have multiple transformers arranged sequentially, each transformer may compute self-attention independently at each block, incurring significant computational cost.

In aspects of the present disclosure, information relating to the self-attention output of one or more transformers in the architecture can be propagated to one or more other transformers in the architecture, and reused by these receiving transformers. Such dependencies on the self-attention maps across transformer blocks can significantly reduce the computational expense of the model while maintaining high accuracy. That is, some or all of the computation performed to compute self-attention at one transformer can be propagated and re-used by one or more other transformers, thereby improving the computational efficiency of the model. Further, in some aspects, this propagation can serve as a form of regularization, improving model generalization and robustness. Additionally, in some aspects, the independently computed self-attention at two transformers may be highly similar (e.g., with high cosine similarity). In such cases, propagating the attention can have negligible effect on model accuracy (and can even improve accuracy, in some deployments).

As used herein, attention propagation output (also referred to as attention information) may refer to any portion of the self-attention information, including the attention matrix A, the features f, and the like. For example, a first (e.g., upstream) transformer may compute self-attention features as f=A·V, where f is the features at the first transformer, A is the attention matrix at the first transformer, and V is the value matrix at the first transformer. A second (e.g., downstream) transformer may reuse some or all of this attention propagation output. For example, the second transformer may compute self-attention features as f′=A·V′ or as f′=Φ(A)·V′, where f′ represents the features at the second transformer, A is the attention matrix received from the first transformer, Φ is a transformation function (e.g., upsampling, convolution, and the like), and V′ is the value matrix at the second transformer. By avoiding at least some computation of the attention matrix at the second transformer, computational expense is substantially reduced. As another example, the second transformer may compute self-attention features as f′=f, or as f′=Φ(f), where Φ is a transformation function (e.g., upsampling, convolution, and the like). That is, the second transformer may re-use the entirety of the attention features generated by the first transformer module, rather than solely the attention map.

In some aspects, rather than propagating the attention information directly (e.g., using an identity mapping), the architecture may use various propagation operations, such as one or more convolution operations, to dynamically modify or update the attention information before providing this information to the downstream transformer(s).

By using such attention propagation, aspects of the present disclosure enable significantly reduced computational expense and improved transformer efficiency. This can enable transformer-based models to be used effectively on resource-constrained devices, such as wearables and other mobile devices.

### Example Architecture for Propagation of Transformer-Generated Attention Output

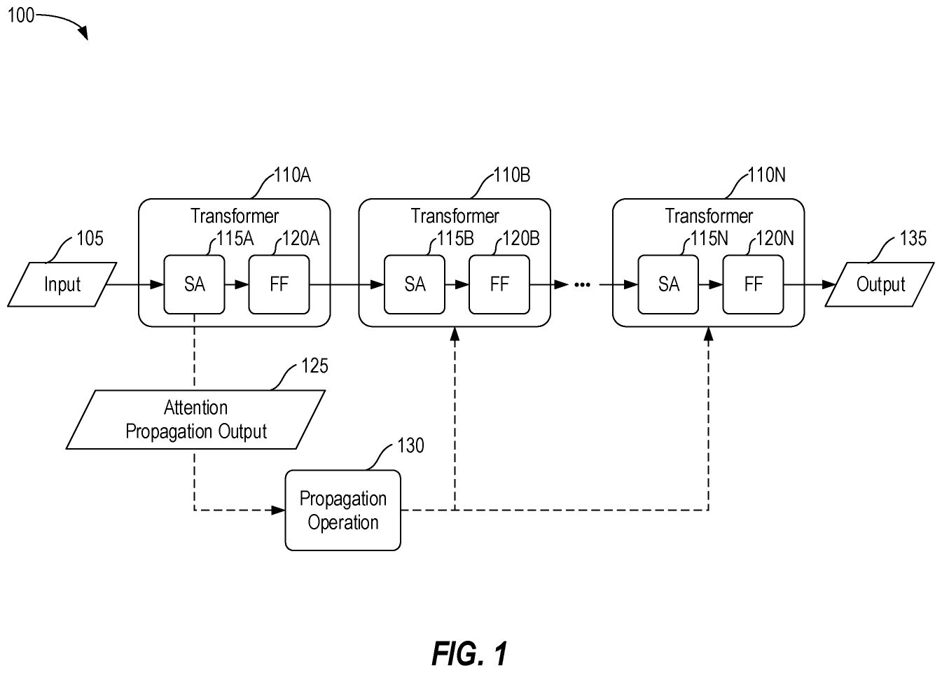

FIG. 1 depicts an example architecture 100 for propagation of transformer-generated attention output.

In the illustrated example, a machine learning model architecture comprising a sequence of transformers 110A-N (collectively, transformers 110, also referred to as transformer blocks and/or transformer components, in some aspects) is depicted. Generally, there may be any number of transformers 110 in the architecture 100. Further, though not included in the illustrated example, in aspects, there may be various other components or blocks in the architecture 100 (e.g., one or more neural networks, multilayer perceptrons, and the like).

As illustrated, input data 105 is provided as input to the architecture 100 to generate an output data 135. The specific form and content of the input data 105 and output data 135 may vary depending on the particular implementation. For example, in some aspects, the input data 105 and output data 135 comprise image data. The output data 135 may also be utilized to generate a processing result, such as image classification, machine translation, object detection, speech recognition, and the like.

In the depicted architecture 100, each transformer 110A-N comprises a corresponding self-attention sub-block 115 (also referred to as a self-attention block and/or a self-attention component, in some aspects) and a feedforward sub-block 120 (also referred to as an MLP block, an MLP component, an MLP sub-block, a feedforward block, and/or a feedforward component, in some aspects). Specifically, the transformer 110A includes a self-attention sub-block 115A and a feedforward sub-block 120A, the transformer 110B includes a self-attention sub-block 115B and a feedforward sub-block 120B, and the transformer 110N includes a self-attention sub-block 115N and a feedforward sub-block 120N. Although not depicted in the illustrated example, in some aspects, each transformer 110 may include one or more residual connections, such as to perform element-wise summation of the input to the self-attention sub-block 115 with the output from the same self-attention sub-block 115, to perform element-wise summation of the input to the feedforward sub-block 120 with the output of the same feedforward sub-block 120, and the like.

In aspects of the present disclosure, the operations performed by “self-attention” components or blocks may generally include any variants of attention, including factorized self-attention, local self-attention, hybrid self-attention, window self-attention, and the like. In some aspects, self-attention sub-blocks 115 may implement multi-head self-attention (MSA).

Though not depicted in the illustrated example, in some aspects, the input data 105 (e.g., an image) is first preprocessed to generate a tokenized image (also referred to as a set of features) prior to being used as input to the first transformer 110A. For example, suppose the input data 105 is an image x∈ [symbol] where h×w is the spatial resolution (e.g., height and width in pixels) and c is the number of channels. In some aspects, the input data 105 may first be tokenized into n=hw/p² non-overlapping patches, where p×p is the patch size. Each patch can then be projected into an embedding zᵢ∈ [symbol] , such as by using a linear layer to obtain a tokenized image Z₀=(z₁; . . . ; zₙ)∈ [symbol] where “;” denotes row-wise stacking, and d denotes the dimension of vector space [symbol] . The tokenized image can then be used as input to the first transformer 110A. In some aspects, positional embeddings can additionally be added to the tokenized image to retain positional information. In some aspects (e.g., in a supervised setting), a learnable token may also be prepended to the tokenized image.

In conventional architectures, as discussed above, each self-attention sub-block 115A-N (collectively, self-attention sub-blocks 115) may compute self-attention independently from the others. In the illustrated example, however, the transformer 110A outputs attention propagation output 125, which is propagated using a propagation operation 130 to one or more downstream transformers (e.g., to the transformer 110B and/or the transformer 110N). Although the illustrated example depicts the attention propagation output 125 being propagated to both the transformer 110B and the transformer 110N, in aspects, one or more of the transformers 110 may receive propagated attention information from one or more other transformers, or may also compute their own self-attention, rather than receiving propagated attention information.

In some aspects, the transformer(s) 110 that propagate attention output and the transformer(s) 110 that receive the propagated attention information may vary depending on the particular implementation. In at least one aspect, the architecture 100 can propagate the attention information from one or more transformer blocks to one or more subsequent intermediate transformer blocks, of a sequence of transformer blocks, of the model. That is, because the attention within such intermediate transformers (e.g., after one or more initial transformers, but prior to one or more final or output transformers) may generally be relatively similar, the architecture 100 may include propagating the attention information from a first intermediate block (e.g., the second or third transformer in the sequence) to one or more subsequent (intermediate) blocks.

In some aspects, the particular content of the attention propagation output 125 may vary depending on the particular implementation. For example, in at least one aspect, the attention propagation output 125 corresponds to the attention values (e.g., attention matrix A) generated by the self-attention sub-block 115A of the transformer 110A and used to generate the output features. In some aspects, the attention propagation output 125 corresponds to the output features themselves (e.g., the features f) generated by the self-attention sub-block 115A of the transformer 110A and provided as input to the feedforward sub-block 120A.

In some aspects, the particular operations or transformations applied by the propagation operation 130 may vary depending on the particular implementation. For example, in some aspects, the propagation operation 130 is an identity operation that simply maps or provides the attention propagation output 125 to the downstream transformer(s) 110 without modification. In some aspects, the propagation operation 130 can include one or more transformations. In some aspects, the transformations applied by the propagation operation 130 can ensure that directly reusing the attention and/or features from a prior transformer 110 does not affect the translation invariance and equivariance in subsequent blocks, and can further act as a strong regularizer to improve model generalization. For example, the transformations may be implemented by a parametric function with one or more learned parameters refined, during training, to improve generalization and preserve invariance and equivariance (as compared to simply copying the features).

In some aspects, the propagation operation 130 can be implemented using a parametric or parameterized function. That is, in at least one aspect, the propagation operation 130 can be performed based in part on one or more learned parameters, such as weights. In some aspects, the propagation operation 130 can include one or more convolution operations. In some aspects, the propagation operation 130 can be implemented as an inverted bottleneck operation (e.g., a fully connected linear layer of a neural network, followed by a depthwise convolution, and followed by another fully connected layer). For example, the propagation operation 130 may upsample the input data in the channel dimension (e.g., from d to 4d), apply a depthwise convolution (e.g., using a 5×5 kernel), and then downsample back to d dimensions. In some aspects, different propagation operations 130 may be performed for each downstream transformer, and/or the same operation may be used with different learned parameters for each downstream transformer.

In some aspects, the propagation operation 130 can include other upsampling and/or downsampling operations. For example, in a window self-attention implementation (or other architectures) where the output features of the propagating self-attention sub-block 115A differ from the output features of the receiving self-attention sub-blocks 115B-115N and/or the receiving feedforward sub-blocks 120B-120N, the propagation operation 130 may upsample the attention propagation output 125 appropriately (e.g., to match the size and dimensionality of the output of the receiving self-attention sub-block(s)), or the attention propagation output 125 may be concatenated with the input to the downstream transformer.

In the illustrated architecture 100, the propagated attention information (e.g., the attention propagation output 125 and/or the attention propagation output 125 modified via the propagation operation 130 (also referred to as the modified attention propagation output)) is provided to each of downstream transformers 110B-110N. Generally, the particular techniques by which the propagated attention information is provided and/or used may vary depending on the particular content of the information (e.g., whether this content includes the attention matrix or the output features of the self-attention sub-block 115A), the architecture 100, and the particular implementation.

For example, in some aspects, if the attention propagation output 125 corresponds to the attention matrix of the self-attention sub-block 115A, then the propagated attention information may be used as the attention matrix of the self-attention sub-blocks 115B to 115N. That is, the architecture 100 may only compute the value matrix for the self-attention sub-blocks 115B to 115N, and compute the dot product with the propagated attention matrix from self-attention sub-block 115A. In this way, the self-attention sub-blocks 115B to 115N need not generate their own attention matrices, thereby significantly reducing the computational expense of the architecture 100.

As another example, in some aspects, if the attention propagation output 125 corresponds to the output features of the self-attention sub-block 115A, then the propagated attention information may be used as the output features of the self-attention sub-blocks 115B to 115N, and/or may be combined with the output features of the self-attention sub-blocks 115B to 115N (or with the input to the self-attention sub-blocks 115B to 115N). That is, the transformers 110B to 110N may simply use the propagated output feature information as the features that would be generated by self-attention sub-blocks 115B to 115N, and these self-attention sub-blocks may therefore refrain from performing any operations (or may be omitted entirely).

In some aspects, the output features propagated from the self-attention sub-block 115A may be aggregated or combined with the input features to the transformers 110B-N. For example, the features output by the feedforward sub-block 120A, which would conventionally be provided to the self-attention sub-block 115B, may instead be combined with the propagated output features from self-attention sub-block 115A (e.g., concatenated together). This combined data can then be provided as input to the feedforward sub-block 120B. Thus, in some aspects, the self-attention sub-block 115B may be unneeded. Similarly, the features output by the transformer immediately preceding the transformer 110N, which would conventionally be provided to the self-attention sub-block 115N, may instead be combined with the propagated output features from the self-attention sub-block 115A (e.g., concatenated together). This combined data can then be provided as input to the feedforward sub-block 120N, and the self-attention sub-block 115N may be unneeded.

Generally, as discussed above, the attention propagation implemented in the architecture 100 can thereby enable significantly reduced computational burden (e.g., a reduced memory footprint, a reduced number of operations, and the like) while maintaining or enhancing model accuracy.

### Example Transformer Architectures for Propagating Attention Data

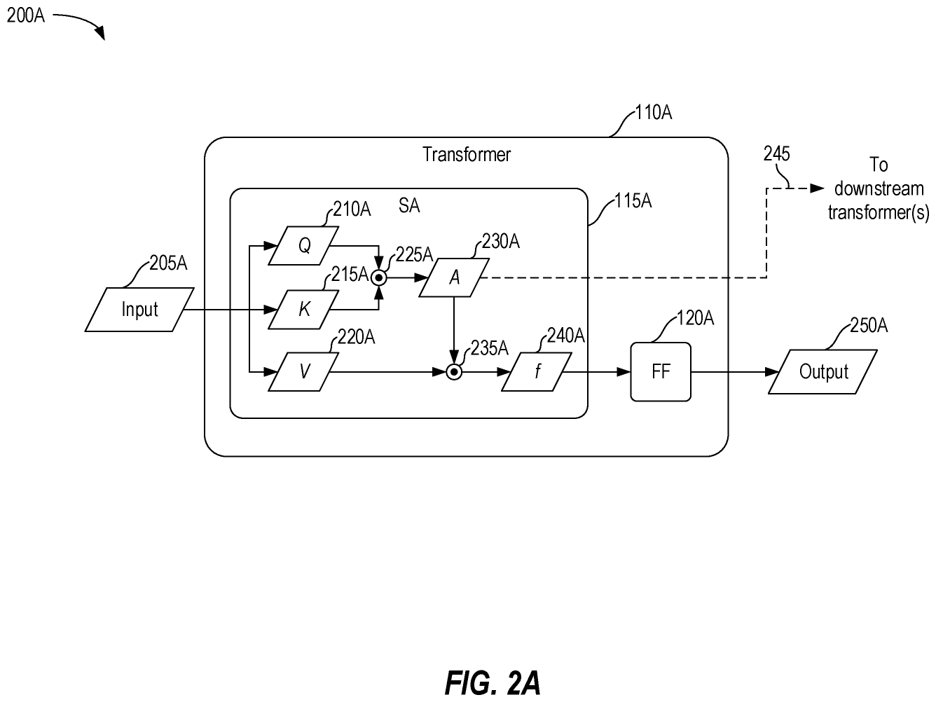

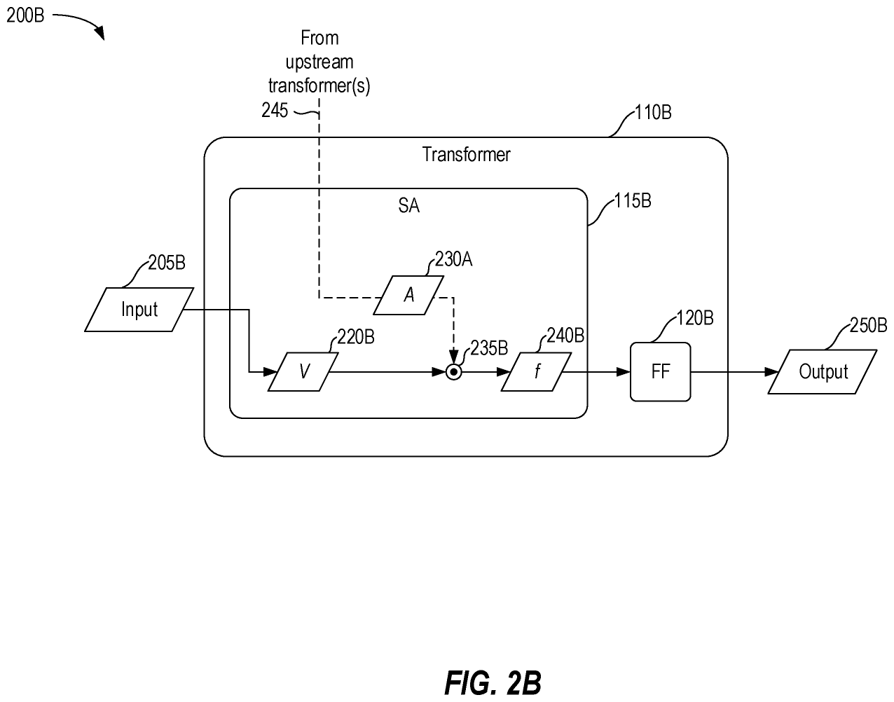

FIGS. 2A and 2B depict example transformer architectures for propagating attention data. In some aspects, the architecture 200A of FIG. 2A provides additional detail for a transformer that propagates or provides attention information for other transformer(s). For example, the architecture 200A may provide additional detail for the transformer 110A of FIG. 1. Similarly, the architecture 200B of FIG. 2B provides additional detail for a transformer that receives or accesses propagated attention information from other transformer(s). For example, the architecture 200B may provide additional detail for the transformer 110B of FIG. 1.

As illustrated in FIG. 2A, input data 205A is accessed by the transformer 110A. As used herein, accessing data can generally include receiving, retrieving, requesting, or otherwise gaining access to the data. As discussed above, the input data 205A may correspond to the input to the first transformer of a model (e.g., the raw or preprocessed input data), the output of a prior transformer or other model component or block, and the like. For example, as discussed above, the input data 205A may correspond to a tokenized input image (which may optionally include positional embedding(s) and/or learnable token(s)).

As discussed above, the transformer 110A includes the self-attention sub-block 115A and the feedforward sub-block 120A. Within the self-attention sub-block 115A, the input data 205A is used to generate a query matrix 210A, key matrix 215A, and value matrix 220A. For example, the self-attention sub-block 115A may use learned weights or other parameters to generate the matrices based on the input data (e.g., using linear projection).

As indicated by the operation 225A (which may correspond to a dot product and/or transposition operation), the attention matrix 230A for the self-attention sub-block 115A is generated based on the query matrix 210A and key matrix 215A. For example, as discussed above, the attention matrix 230A may be generated by computing the dot product between the transposed key matrix 215A and the query matrix 210A. Although not depicted in the illustrated example, in some aspects, the result of this dot product can be further processed or transformed, such as using a softmax operation (or other operation), to form the attention matrix 230A.

As indicated by operation 235A (which may correspond to a dot product), output features 240A (also referred to as attention features) for the self-attention sub-block 115A may be generated based on the value matrix 220A and the attention matrix 230A.

These output features 240A are then provided as input to the feedforward sub-block 120A, which generates output 250A from the transformer 110A. This output 250A may then be used as input to a subsequent block or component, such as to the transformer 110B of FIG. 1. In some aspects, as discussed above, the feedforward sub-block 120A comprises an MLP including two linear layers separated by a Gaussian error linear unit (GeLU) activation function.

Although not depicted in the illustrated example, in some aspects, the transformer 110A may include one or more skip or residual connections (with or without layer normalization). For example, the output features 240A may be generated by summing the output of the operation 235A with the input data 205A. As another example, the output 250A of the transformer 110A may be generated by summing the output of the final layer of the feedforward sub-block 120A with the output features 240A.

In the illustrated example, the attention matrix 230A is further provided, via link 245, to one or more downstream transformer(s). That is, the attention matrix 230A may correspond to the attention propagation output 125 of FIG. 1. In some aspects, as discussed above, the attention matrix 230A is processed using one or more propagation operations prior to being provided to the downstream transformer(s). For example, the propagation operation may include an identity operation, one or more convolution operations, a bottleneck operation, an upsampling or downsampling operation, and the like.

In this way, the architecture 200A enables the attention matrix 230A to be used by one or more subsequent transformers, thereby enabling them to bypass such computation and significantly improving the efficiency of the model.

Turning now to FIG. 2B, input data 205B is accessed by the transformer 110B. Generally, the transformer 110B may be downstream from or subsequent to the transformer 110A. That is, if the model includes a sequence of transformer blocks, then transformation by the operations of the transformer 110A may be performed relatively earlier in the sequence, as compared to the operations of the transformer 110B. However, it is to be understood that the transformer 110B need not be the immediately adjacent or immediately subsequent transformer, relative to the transformer 110A. In some aspects, the input data 205B may be received from a prior model component, such as a prior transformer (e.g., the output of the feedforward sub-block of a prior transformer).

As discussed above, the transformer 110B includes the self-attention sub-block 115B and the feedforward sub-block 120B. As illustrated, rather than independently computing attention (e.g., generating an attention matrix based on the input data 205B), the self-attention sub-block 115B can receive the propagated attention matrix 230A from the transformer 110A via the link 245. Although the illustrated example depicts receiving the attention matrix 230A itself for conceptual clarity (e.g., via an identity operation), as discussed above, the propagation operation may additionally or alternatively include one or more transformations or modifications to the attention matrix 230A prior to providing the attention matrix to the self-attention sub-block 115B.

In this way, within the self-attention sub-block 115B, the input data 205B is used to generate a value matrix 220B. Thus, in some aspects, a query matrix and key matrix need not be generated for the self-attention sub-block 115B. For example, the self-attention sub-block 115B may use learned weights or other parameters to generate the value matrix 220B based on the input data (e.g., using linear projection).

Further, the self-attention sub-block 115B need not perform a dot product, transposition, or softmax operation on any query or key matrices, as the (potentially transformed) attention matrix 230A from the transformer 110A is re-used.

As indicated by operation 235B (which may correspond to a dot product), output features 240B for the self-attention sub-block 115B may thereby be generated based on the value matrix 220B and the propagated attention matrix 230A. These output features 240B may be then provided as input to the feedforward sub-block 120B, which generates output 250B from the transformer 110B. This output 250B may then be used as input to a subsequent block or component, or as output from the model.

Although not depicted in the illustrated example, in some aspects, the transformer 110B may include one or more skip or residual connections (with or without layer normalization), as discussed above. For example, the output features 240B may be generated by summing the output of the operation 235B with the input data 205B. As another example, the output 250B of the transformer 110B may be generated by summing the output of the final layer of the feedforward sub-block 120B with the output features 240B.

In the illustrated example, therefore, the computational resources consumed when processing the input data 205B in the transformer 110B are substantially reduced, as compared to conventional architectures in which attention is computed at each transformer independently. In this way, the architecture 200B enables significantly improved efficiency of the model.

### Example Transformer Architectures for Propagating Attention Feature Data

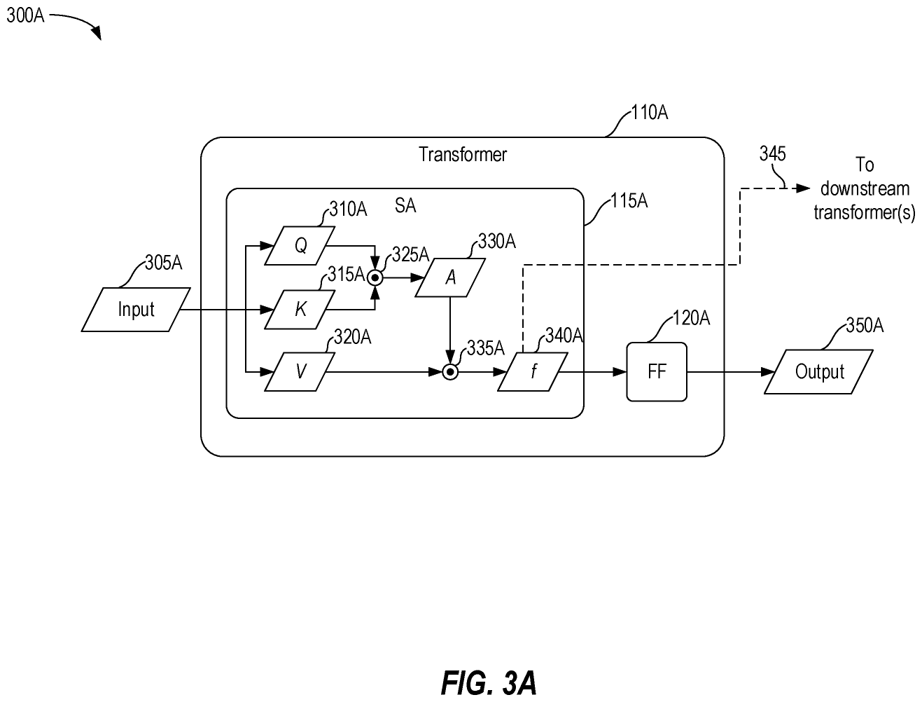

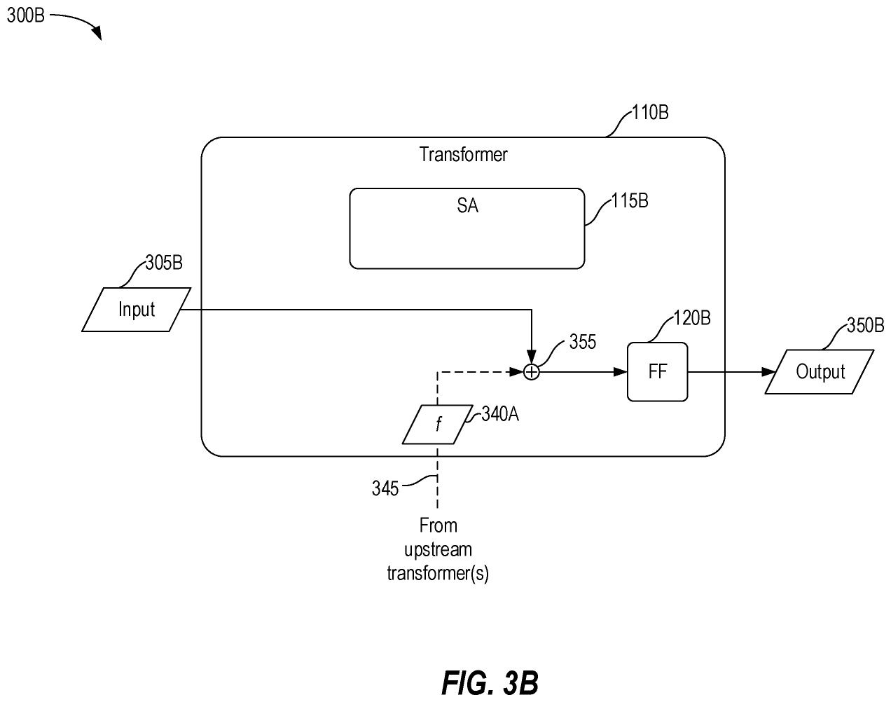

FIGS. 3A and 3B depict example transformer architectures for propagating attention feature data. In some aspects, the architecture 300A of FIG. 3A provides additional detail for a transformer that propagates or provides attention information for other transformer(s). For example, the architecture 300A may provide additional detail for the transformer 110A of FIG. 1. Similarly, the architecture 300B of FIG. 3B provides additional detail for a transformer that receives or accesses propagated attention information from other transformer(s). For example, the architecture 300B may provide additional detail for the transformer 110B of FIG. 1.

As illustrated in FIG. 3A, input data 305A is accessed by a transformer 110A having a self-attention sub-block 115A and a feedforward sub-block 120A. For example, as discussed above, the input data 305A may correspond to a tokenized input image (which may optionally include positional embedding(s) and/or learnable token(s)). In some aspects, the operations of the self-attention sub-block 115A and the feedforward sub-block 120A may generally correspond to the operations discussed above with reference to FIG. 2A. For example, the input data 305A may be used to generate query matrix 310A, key matrix 315A, and value matrix 320A, which may then be used to generate (via operations 325A and 335A) an attention matrix 330A and output features 340A, respectively. The output features 340A are then provided to the feedforward sub-block 120A, which processes the features 340A to generate the output 350A for the transformer 110A. Although not depicted in the illustrated example, in some aspects, the transformer 110A can further include one or more residual or skip connections (e.g., for the self-attention sub-block 115A and/or for the feedforward sub-block 120A), as discussed above.

In the illustrated example, the output features 340A are further provided, via link 345, to one or more downstream transformer(s). That is, the output features 340A may correspond to the attention propagation output 125 of FIG. 1. In some aspects, as discussed above, the output features 340A are processed using one or more propagation operations prior to being provided to the downstream transformer(s). For example, the propagation operation may include an identity operation, one or more convolution operations, a bottleneck operation, an upsampling or downsampling operation, and the like.

In some aspects, the link 345 comprises a parametric or parameterized function that maps the output of the self-attention sub-block 115A (e.g., the output features 340A) for use by one or more subsequent or downstream transformers. In some aspects, as discussed above, the link 345 is an identity function. In some aspects, the link 345 can encode local relations among tokens. For example, the link 345 may comprise a sequence of convolutions, such as two linear layers with a depth-wise convolution between the linear layers. This may be useful, for instance, if the link 345 comprises an identity function because due to the absence of self-attention at the downstream transformer (e.g., due to the fact that the downstream transformer re-uses the output features 340A without modification and without generating its own attention) representation learning can be affected since the relation across tokens may no longer be encoded in the attention matrix.

In some aspects, in the case of supervised learning, the learnable tokens (discussed above, which may be prepended to the input data) can be separated into class embeddings and patch embeddings, where the patch embeddings are input to the first linear layer of the link 345. This first layer can expand the channel dimension, and the depthwise convolution layer can then convolve the data using an r×r kernel to capture cross-token relations. Note that in some aspects, prior to the depthwise convolution operation, the input matrix can be spatially reshaped to a feature tensor. The output of the depthwise operation can then be flattened back to a vector and provided to the last linear/fully connected layer of the link 345, which reduces the channel dimension back to the initial depth.

In this way, the architecture 300A enables the output features 340A to be used by one or more subsequent transformers, thereby enabling them to bypass such computation and significantly improving the efficiency of the model.

Turning now to FIG. 3B, input data 305B is accessed by a transformer 110B having a self-attention sub-block 115B and a feedforward sub-block 120B. Generally, the transformer 110B may be downstream from or subsequent to the transformer 110A. That is, if the model includes a sequence of transformer blocks, then the transformer 110A may be performed relatively earlier in the sequence, as compared to the transformer 110B. However, it is to be understood that the transformer 110B need not be the immediately adjacent or immediately subsequent transformer, relative to the transformer 110A.

As discussed above, the transformer 110B includes a self-attention sub-block 115B and a feedforward sub-block 120B. As illustrated, rather than independently computing attention or output features, the self-attention sub-block 115B may be unused (and may be omitted in some implementations) and the propagated output features 340A from the transformer 110A (accessed via the link 345) may instead be used. Although the illustrated example depicts receiving the output features 340A themselves for conceptual clarity (e.g., via an identity operation), as discussed above, the propagation operation may additionally or alternatively include one or more transformations or modifications to the output features 340A prior to providing the (modified) output features to the transformer 110B.

As illustrated, rather than computing self-attention using the self-attention sub-block 115B, the transformer 110B may combine the input data 305B and propagated output features 340A via operation 355. For example, the operation 355 may correspond to a concatenation, element-wise addition or summation, averaging, and the like. As illustrated, the resulting output is then provided as input to the feedforward sub-block 120B, which generates the output data 350B from the transformer 110B. In some aspects, rather than combining the input data 305B and the propagated output features 340A, the propagated output features 340A may themselves be used as the input to the feedforward sub-block 120B, and the input data 305B may be unused or discarded. For example, the output features 340A may be upsampled and provided to the feedforward sub-block 120B to generate output data 350B, and both the input data 305B and the self-attention sub-block 115B may be unused, discarded, or omitted. As illustrated, the output data 350B may then be used as input to a subsequent block or component, or as output from the model.

Although not depicted in the illustrated example, as discussed above, the transformer 110B may include one or more skip or residual connections (with or without layer normalization), in some aspects. For example, the summation operation 355 may effectively implement a residual connection to generate the input to the feedforward sub-block 120B. Additionally, the output data 350B of the transformer 110B may be generated by summing the output of the final layer of the feedforward sub-block 120B with the output of the operation 355. In this way, due to the presence of such residual connections, the transformers 110 that re-use prior attention data may still learn representations independently and still provide useful computation, even without performing independent self-attention.

In the illustrated example, therefore, the computational resources consumed when processing the input data 305B in the transformer 110B are substantially reduced, as compared to conventional architectures in which attention is computed at each transformer independently. In this way, the architecture 300B enables significantly improved efficiency of the model.

### Example Machine Learning Architecture Using Transformers and Attention Propagation

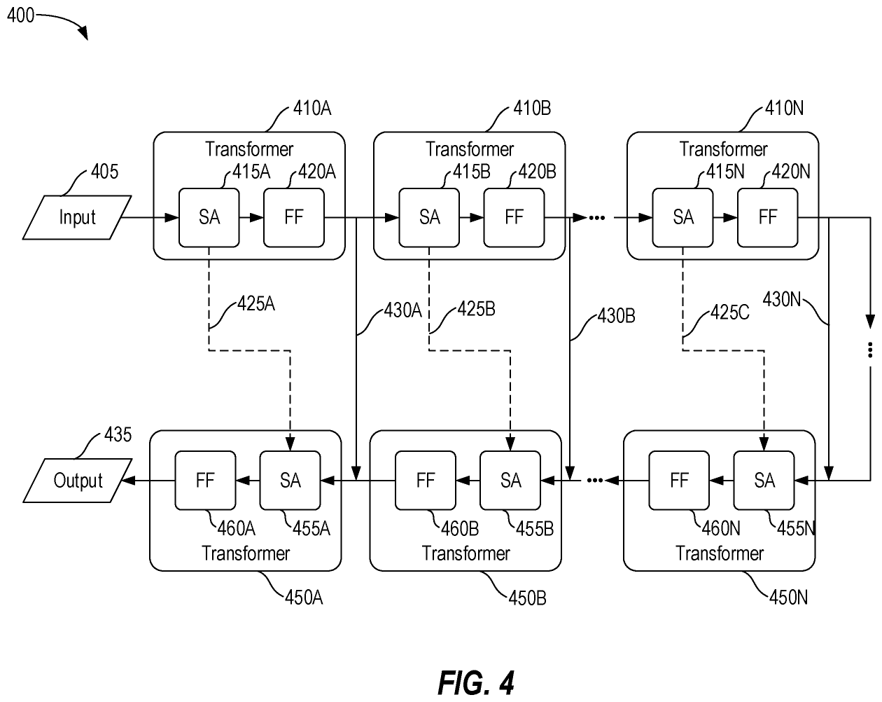

FIG. 4 depicts an example machine learning architecture 400 using transformers and attention propagation. In one aspect, the architecture 400 corresponds to an encoder-decoder architecture, where input data 405 is processed sequentially using one or more encoder transformers 410A-410N (collectively, encoder transformers 410), followed by one or more decoder transformers 450A-450N (collectively, decoder transformers 450), to generate output data 435. The output data 435 may be utilized to obtain a wide variety of processing results, such as image classifications, machine translation, object detection, speech recognition and the like.

As illustrated, the input data 405 is accessed by a first encoder transformer 410A, and processed using the self-attention sub-block 415A to generate output features (also referred to in some aspects as attention features). These features are then processed by feedforward sub-block 420A to generate output from the encoder transformer 410A. In the illustrated example, the output from the encoder transformer 410A is provided as input to the encoder transformer 410B (comprising self-attention sub-block 415B and feedforward sub-block 420B). Although not depicted in the illustrated example, in some aspects, the transformers 410 and 450 may include one or more residual connections for the self-attention sub-blocks 415 and 455 and/or for the feedforward sub-blocks 420 and 460, as discussed above.

In the illustrated example, as indicated by link 430A, the output from the encoder transformer 410A is also concatenated with the input to a corresponding decoder transformer 450A. That is, the output of encoder transformer 410A is concatenated with the output of decoder transformer 450B, and the concatenated data is provided as input to the decoder transformer 450A (which includes self-attention sub-block 455A and feedforward sub-block 460A).

In addition, as illustrated by link 425A, attention propagation output is further provided from the self-attention sub-block 415A to the self-attention sub-block 455A. For example, the attention map or matrix generated by the self-attention sub-block 415A may be propagated to the self-attention sub-block 455A, allowing the self-attention sub-block 455A to re-use the attention information and refrain from independently computing the self-attention. In some aspects, as discussed above, this propagation operation may include an identity mapping, or may include a variety of transformations, such as upsampling, convolutions, and the like. Although the illustrated example depicts propagation of attention information from an encoder to a decoder, in some aspects, attention may additionally or alternatively be propagated to other transformers (e.g., from a first encoder to a subsequent encoder).

In the illustrated example, each encoder transformer 410 propagates its output to a corresponding decoder transformer 450 (as indicated by links 430A-430N), and further propagates attention information to the corresponding decoder transformer 450 (as indicated by links 425A-425N). Specifically, in addition to encoder transformer 410A and decoder transformer 450A discussed above, the encoder transformer 410B (comprising self-attention sub-block 415B and feedforward sub-block 420B) propagates attention information via link 425B and output via link 430B to decoder transformer 450B (comprising self-attention sub-block 455B and feedforward sub-block 460B), and the encoder transformer 410N (comprising self-attention sub-block 415N and feedforward sub-block 420N) propagates attention information via link 425N and output via link 430N to decoder transformer 450N (comprising self-attention sub-block 455N and feedforward sub-block 460N).

Though three encoder transformers 410 and three decoder transformers 450 are depicted for conceptual clarity, there may be any number of encoders and decoders in the architecture 400. Further, in various aspects, there may be one or more components or blocks between the final encoder transformer and the first decoder transformer, or the final encoder transformer may provide its output directly to the first decoder transformer 450.

Generally, in the illustrated example, the corresponding decoder transformer 450 for each encoder transformer 410 is defined based on the sequence of transformers used. For example, the first encoder transformer 410A corresponds to the final decoder transformer 450A, the second encoder transformer 410B corresponds to the penultimate decoder transformer 450B, the final encoder transformer 410N corresponds to the first decoder transformer 450N, and so on.

In this way, the architecture 400 enables attention information from one or more encoder transformers 410 to be propagated and re-used by one or more subsequent decoder transformers 450 (or by other encoder transformers 410), and/or for attention information from one or more decoder transformers 450 to be propagated and re-used by one or more subsequent decoder transformers 450. As discussed above, this substantially reduces the computational expense of the architecture 400, while further maintaining or improving model accuracy.

### Example Method for Generating and Providing Attention Propagation Output

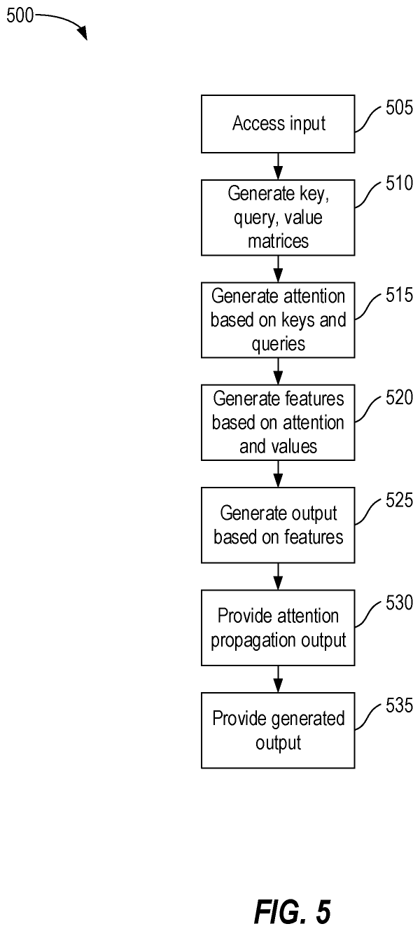

FIG. 5 is a flow diagram depicting an example method 500 for generating and providing attention propagation output. In some aspects, the method 500 is performed by an upstream transformer that generates self-attention to be propagated to one or more downstream transformers. For example, the method 500 may be performed by the transformer 110A of FIGS. 1, 2A, and/or 3A, by encoder transformers 410A-N of FIG. 4, and/or by decoder transformers 450A-N of FIG. 4.

At block 505, the transformer accesses input data. As discussed above, this input may include input to the model itself, output from a prior block or component of the model (e.g., a prior transformer), and the like. For example, the accessed input may correspond to the input data 105 of FIG. 1, input data 205A of FIG. 2A, input data 305A of FIG. 3A, input data 405 of FIG. 4, the output of an encoder transformer 410 of FIG. 4, and the like. In some aspects, the accessed input data corresponds to tokenized image data, as discussed above. The accessed data is generally used as the input to the transformer, and is processed to generate output from the transformer (e.g., using self-attention and/or a feedforward network).

At block 510, the transformer generates the key, query, and value matrices for the transformer based on the input. For example, as discussed above with reference to FIGS. 2A and 3A, the transformer may use learned parameters and/or linear projection to generate the matrices (e.g., by multiplying the accessed input with learned values).

At block 515, the transformer generates attention (e.g., an attention map or matrix) based on the generated keys and queries. For example, as discussed above, the transformer may compute the dot product of the key matrix and the transposed query matrix, and apply a softmax operation (or other operation) to the result to generate the attention matrix.

At block 520, the transformer generates output features (also referred to as attention features or self-attention features, as discussed above) based on the generated attention and values. For example, as discussed above, the transformer may compute the dot product of the attention matrix and value matrix. In some aspects, as discussed above, the output features may be generated further using a residual connection, such as by aggregating the input data (accessed at block 505) and the features (generated based on the attention and values) using an element-wise summation.

At block 525, the transformer can generate the output of the transformer based on the generated features. For example, as discussed above, the transformer may process the features using a feedforward sub-block (e.g., an MLP) of the transformer to generate an output. In some aspects, as discussed above, the output of the transformer may be generated further using a residual connection, such as by aggregating the output features (generated at block 520) and the output of the feedforward sub-block using an element-wise summation.

At block 530, the transformer provides attention propagation output (e.g., the attention matrix and/or the output features) as output. For example, via a propagation operation (e.g., an identity mapping or skip connection, one or more convolution operations, or one or more other transformations), the attention propagation output can be provided to and re-used by one or more downstream transformers.

At block 535, the transformer similarly provides the generated output (generated at block 525) as output from the transformer and input to the subsequent or adjacent downstream component (e.g., to the next transformer in a sequence of transformers).

In this way, the method 500 enables the attention information, generated by the transformer, to be propagated and shared and/or re-used by one or more downstream components, thereby substantially reducing computational expense and maintaining or improving model accuracy and robustness.

### Example Method for Generating Output Using Propagated Attention Information

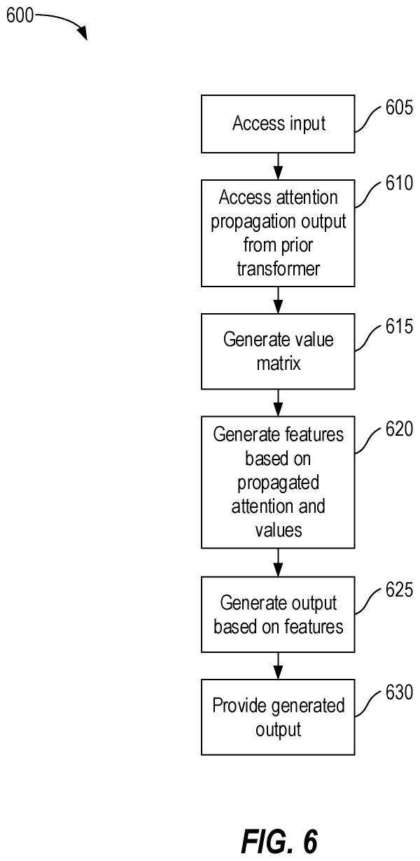

FIG. 6 is a flow diagram depicting an example method 600 for generating output using propagated attention information. In some aspects, the method 600 is performed by a downstream transformer that receives and uses propagated attention information from one or more upstream transformers. For example, the method 600 may be performed by the transformer 110B of FIGS. 1, 2B, and/or 3B, and/or by encoder transformers 410A-N of FIG. 4 and/or decoder transformers 450A-N of FIG. 4.

At block 605, the transformer accesses input data. As discussed above, this input may include output from a prior block or component of the model (e.g., a prior transformer). For example, the accessed input may correspond to the output of transformers 110A/110B of FIG. 1, output 250A of FIG. 2A, input data 205B of FIG. 2B, output 350A of FIG. 3A, input data 305B of FIG. 3B, the output of a decoder transformer 450 of FIG. 4, and the like. The accessed data is generally used as the input to the transformer, and is processed to generate output from the transformer (e.g., using self-attention and/or a feedforward network).

At block 610, the transformer accesses attention information (e.g., attention propagation output) from one or more prior transformers. In some aspects, the attention propagation output corresponds to an attention map or matrix generated by the prior transformer, as discussed above. For example, the accessed input may correspond to the attention propagation output 125 of FIG. 1, attention matrix 230A of FIGS. 2A and 2B, and the like. In some aspects, as discussed above, rather than receiving the attention matrix itself (e.g., via a skip connection), the received attention propagation output corresponds to a transformed or modified attention matrix (e.g., upsampled, processed with one or more convolution operations, and the like).

At block 615, the transformer generates a value matrix based on the input accessed/received at block 605. For example, as discussed above with reference to FIG. 2B, the transformer may use learned parameters and/or linear projection to generate the value matrix (e.g., by multiplying the accessed input with learned values).

At block 620, the transformer generates output features (e.g., self-attention features) based on the propagated attention matrix and the generated value matrix. For example, as discussed above, the transformer may compute the dot product of the propagated attention matrix and the generated value matrix. In some aspects, as discussed above, the output features may be generated further using a residual connection, such as by aggregating the input data (accessed at block 605) and the features (generated based on the attention and values) using an element-wise summation.

At block 625, the transformer can then generate the output of the transformer based on the generated features. For example, as discussed above, the transformer may process the features using a feedforward sub-block (e.g., an MLP) of the transformer to generate an output. In some aspects, as discussed above, the output of the transformer may be generated further using a residual connection, such as by aggregating the output features (generated at block 620) and the output of the feedforward sub-block using an element-wise summation.

At block 630, the transformer then provides the generated output (generated at block 625) as output from the transformer and input to the subsequent or adjacent downstream component (e.g., to the next transformer in a sequence of transformers), or as output from the model.

In this way, the method 600 enables the attention information, generated by an upstream transformer, to be propagated and shared and/or re-used by the downstream transformer, thereby substantially reducing computational expense and maintaining or improving model accuracy and robustness.

### Example Method for Generating Output Using Propagated Feature Information

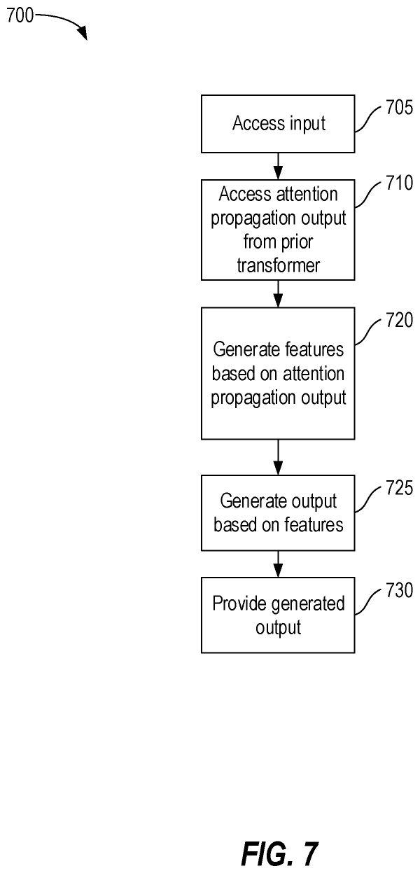

FIG. 7 is a flow diagram depicting an example method 700 for generating output using propagated feature information. In some aspects, the method 700 is performed by a downstream transformer that receives and uses propagated attention information from one or more upstream transformers. For example, the method 700 may be performed by the transformer 110B of FIGS. 1, 2B, and/or 3B, by encoder transformers 410A-N of FIG. 4, and/or by decoder transformers 450A-N of FIG. 4.

At block 705, the transformer accesses input data. As discussed above, this input may include output from a prior block or component of the model (e.g., a prior transformer). For example, the accessed input may correspond to the output of transformers 110A/110B of FIG. 1, output 250A of FIG. 2A, input data 205B of FIG. 2B, output 350A of FIG. 3A, input data 305B of FIG. 3B, the output of a decoder transformer 450 of FIG. 4, and the like. The accessed data is generally used as the input to the transformer, and is processed to generate output from the transformer (e.g., using self-attention and/or a feedforward network).

At block 710, the transformer accesses attention information (e.g., attention propagation output) from one or more prior transformers. In some aspects, the attention propagation output corresponds to the output attention features generated by the prior transformer, as discussed above. For example, the accessed input may correspond to the attention propagation output 125 of FIG. 1, output features 340A of FIGS. 3A and 3B, and the like. In some aspects, as discussed above, rather than receiving the output features themselves (e.g., via a skip connection), the received attention propagation output corresponds to a transformed or modified features (e.g., upsampled, processed with one or more convolution operations, and the like).

At block 720, the transformer optionally generates output features (e.g., self-attention features) based on the propagated features. For example, as discussed above, the transformer may concatenate or sum the input data (received at block 705) and the propagated output features. In some aspects, as discussed above, the transformer can instead simply use the propagated features as its own attention output.

At block 725, the transformer can generate the output of the transformer based on the generated features (e.g., based on the concatenated or summed input and propagated features, or based on the propagated features alone). For example, as discussed above, the transformer may process the features using a feedforward sub-block (e.g., an MLP) of the transformer to generate an output. In some aspects, as discussed above, the output of the transformer may be generated further using a residual connection, such as by aggregating the output features (generated at block 720) and the output of the feedforward sub-block using an element-wise summation.

At block 730, the transformer then provides the generated output (generated at block 725) as output from the transformer and input to the subsequent or adjacent downstream component (e.g., to the next transformer in a sequence of transformers), or as output from the model.

In this way, the method 700 enables the attention information, generated by an upstream transformer, to be propagated and shared and/or re-used by the downstream transformer, thereby substantially reducing computational expense and maintaining or improving model accuracy and robustness.

### Example Method for Propagating Attention Output in Transformer Architectures

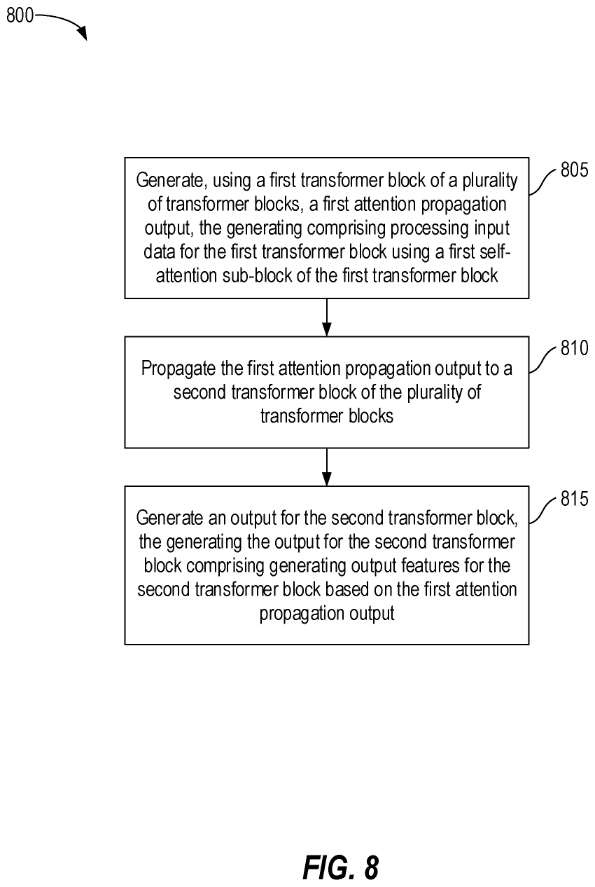

FIG. 8 is a flow diagram depicting an example method 800 for propagating attention output in transformer architectures. In some aspects, the method 800 is performed by one or more upstream transformers that generate self-attention to be propagated to one or more downstream transformers (such as the transformer 110A of FIGS. 1, 2A, and/or 3A, and/or by encoder transformers 410A-N of FIG. 4), and/or by one or more downstream transformers that receive and use propagated attention information from one or more upstream transformers (such as the transformer 110B of FIGS. 1, 2B, and/or 3B, and/or by decoder transformers 450A-N of FIG. 4).

At block 805, a first attention propagation output is generated using a first transformer block of a plurality of transformer blocks, the generating comprising processing input data for the first transformer block using a first self-attention sub-block of the first transformer block.

At block 810, the first attention propagation output is propagated to a second transformer block of the plurality of transformer blocks.

At block 815, an output for the second transformer block is generated, the generating the output for the second transformer block comprising generating output features for the second transformer block based on the first attention propagation output.

In some aspects, generating the first attention propagation output further comprises generating, using the first transformer block, an attention matrix, and generating the attention matrix comprises processing a query representation and a key representation of the input data for the first transformer block using the first self-attention sub-block.

In some aspects, the first attention propagation output comprises the attention matrix.

In some aspects, generating the output features for the second transformer block further comprises accessing an output for a third transformer block of the plurality of transformer blocks, wherein the third transformer block immediately precedes the second transformer block, and generating, using a second self-attention sub-block of the second transformer, the output features for the second transformer block based on the first attention propagation output and a value representation of the output for the third transformer block.

In some aspects, generating the first attention propagation output comprises generating, using the first transformer block, output features for the first transformer block by processing the attention matrix and a value representation of the input data for the first transformer block using the first self-attention sub-block.

In some aspects, the first attention propagation output comprises the output features for the first transformer block.

In some aspects, the method 800 further includes generating, using the first transformer block, an output for the first transformer block, wherein generating the output for the first transformer block comprises processing output features of the first self-attention sub-block using a first feedforward sub-block of the first transformer block.

In some aspects, generating the output for the second transformer block comprises processing the output features of the second self-attention sub-block using a second feedforward sub-block of the second transformer block.

In some aspects, the first transformer block comprises an encoder block, and the second transformer block comprises a decoder block.

In some aspects, the plurality of transformer blocks comprises a sequence of transformer blocks, the sequence of transformer blocks comprises one or more initial blocks, a plurality of intermediate blocks, and one or more final blocks, and the plurality of intermediate blocks comprises the first transformer block and the second transformer block.

In some aspects, generating the first attention propagation output comprises processing the input data for the first transformer block using a plurality of window self-attention operations to generate the output features for the first transformer block.

In some aspects, the first attention propagation output comprises the output features for the first transformer block.

In some aspects, propagating the first attention propagation output to the second transformer block comprises propagating the first attention propagation output using a propagation operation, the propagation operation comprises transforming the first attention propagation output by concatenating output features for a third transformer block of the plurality of transformer blocks to the first attention propagation output, and the third transformer block immediately precedes the second transformer block.

In some aspects, propagating the first attention propagation output to the second transformer block comprises propagating the first attention propagation output using a propagation operation, and the propagation operation comprises transforming the first attention propagation output using an upsampling operation.

In some aspects, propagating the first attention propagation output to the second transformer block comprises propagating the first attention propagation output using a propagation operation.

In some aspects, the propagation operation comprises transforming the first attention propagation output by performing one or more convolution operations on the first attention propagation output.

In some aspects, the propagation operation comprises an identity operation.

In some aspects, when generating the output features for the second transformer block, the second self-attention sub-block does not compute an attention matrix.

### Example Processing System for Efficient Transformer Architecture with Attention Propagation Output

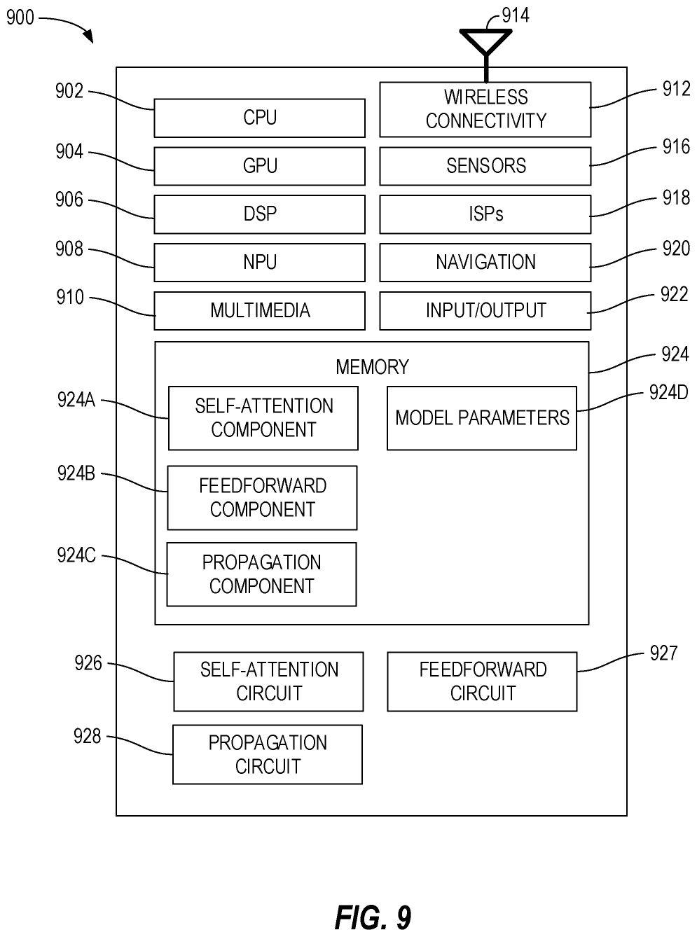

In some aspects, the workflows, techniques, and methods described with reference to FIGS. 1-8 may be implemented on one or more devices or systems. FIG. 9 depicts an example processing system 900 configured to perform various aspects of the present disclosure, including, for example, the techniques and methods described with respect to FIGS. 1-8. In one aspect, the processing system 900 may train, implement, or provide a machine learning model using transformer-based architectures, such as the architecture 100 of FIG. 1, the architecture 200A of FIG. 2A, the architecture 200B of FIG. 2B, the architecture 300A of FIG. 3A, the architecture 300B of FIG. 3B, and/or the architecture 400 of FIG. 4. Although depicted as a single system for conceptual clarity, in at least some aspects, as discussed above, the operations described below with respect to the processing system 900 may be distributed across any number of devices.

Processing system 900 includes a central processing unit (CPU) 902, which in some examples may be a multi-core CPU. Instructions executed at the CPU 902 may be loaded, for example, from a program memory associated with the CPU 902 or may be loaded from a partition of memory 924.

Processing system 900 also includes additional processing components tailored to specific functions, such as a graphics processing unit (GPU) 904, a digital signal processor (DSP) 906, a neural processing unit (NPU) 908, a multimedia processing unit 910, and a wireless connectivity component 912.

An NPU, such as NPU 908, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In one implementation, NPU 908 is a part of one or more of CPU 902, GPU 904, and/or DSP 906.

In some examples, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 912 is further connected to one or more antennas 914.

Processing system 900 may also include one or more sensor processing units 916 associated with any manner of sensor, one or more image signal processors (ISPs) 918 associated with any manner of image sensor, and/or a navigation component 920, which may include satellite-based positioning system components (e.g., GPS or GLONASS) as well as inertial positioning system components.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM, RISC-V, MIPS, or X86 instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned processors of processing system 900.

In particular, in this example, memory 924 includes a self-attention component 924A, a feedforward component 924B, and a propagation component 924C. Though depicted as discrete components for conceptual clarity in FIG. 9, the illustrated components (and others not depicted) may be collectively or individually implemented in various aspects.

In the illustrated example, the memory 924 further includes model parameters 924D. The model parameters 924D may generally correspond to the learnable or trainable parameters of one or more machine learning models, such as used to generate self-attention, to control attention propagation operations, to process attention features to generate transformer output, and the like.

Though depicted as residing in memory 924 for conceptual clarity, in some aspects, some or all of the model parameters 924D may reside in any other suitable location.

Processing system 900 further comprises self-attention circuit 926, feedforward circuit 927, and propagation circuit 928. The depicted circuits, and others not depicted, may be configured to perform various aspects of the techniques described herein.

In an aspect, self-attention component 924A and self-attention circuit 926 may be used to generate or perform self-attention in one or more transformer blocks, as discussed above. For example, the self-attention component 924A and self-attention circuit 926 may implement the operations of one or more self-attention sub-blocks 115 of FIGS. 1, 2A, 2B, 3A, and/or 3B, and/or self-attention sub-blocks 415 and/or 455 of FIG. 4.

Feedforward component 924B and feedforward circuit 927 may be used to generate output data based on attention features in one or more transformer blocks, as discussed above. For example, the feedforward component 924B and feedforward circuit 927 may implement the operations of one or more feedforward sub-blocks 120 of FIGS. 1, 2A, 2B, 3A, and/or 3B, and/or feedforward sub-blocks 420 and/or 460 of FIG. 4.

Propagation component 924C and propagation circuit 928 may be used to propagate attention information (e.g., attention matrices and/or output attention features) from one or more upstream transformer blocks to one or more downstream transformer blocks, as discussed above. For example, the propagation component 924C and propagation circuit 928 may implement the operations of propagation operation 130 of FIG. 1, the link 245 of FIGS. 2A and 2B, the link 345 of FIGS. 3A and 3B, and/or the links 425 of FIG. 4.

Though depicted as separate components and circuits for clarity in FIG. 9, self-attention circuit 926, feedforward circuit 927, and propagation circuit 928 may collectively or individually be implemented in other processing devices of processing system 900, such as within CPU 902, GPU 904, DSP 906, NPU 908, and the like.

Generally, processing system 900 and/or components thereof may be configured to perform the methods described herein.

Notably, in other aspects, aspects of processing system 900 may be omitted, such as where processing system 900 is a server computer or the like. For example, multimedia processing unit 910, wireless connectivity component 912, sensor processing units 916, ISPs 918, and/or navigation component 920 may be omitted in other aspects. Further, aspects of processing system 900 maybe distributed between multiple devices.

### EXAMPLE CLAUSES

Implementation examples are described in the following numbered clauses:

Clause 1: generating, using a first transformer block of a plurality of transformer blocks, a first attention propagation output, the generating comprising processing input data for the first transformer block using a first self-attention sub-block of the first transformer block; propagating the first attention propagation output to a second transformer block of the plurality of transformer blocks; and generating an output for the second transformer block, the generating the output for the second transformer block comprising generating output features for the second transformer block based on the first attention propagation output. In some aspects, the output features for the second transformer block are generated using a second self-attention sub-block of the second transformer block. One advantage of Clause 1 is that attention information can be re-used, thereby reducing computational expense.

Clause 2: A method according to Clause 1, wherein: generating the first attention propagation output further comprises generating, using the first transformer block, an attention matrix, and generating the attention matrix comprises processing a query representation and a key representation of the input data for the first transformer block using the first self-attention sub-block. One advantage of Clause 2 is that the attention matrix can be generated by a first transformer and re-used by a downstream transformer.

Clause 3: A method according to Clause 1 or 2, wherein the first attention propagation output comprises the attention matrix. One advantage of Clause 3 is that the second transformer need not generate its own attention matrix, thereby reducing expense.

Clause 4: A method according to any of Clauses 1-3, wherein generating the output features for the second transformer block further comprises: accessing an output for a third transformer block of the plurality of transformer blocks, wherein the third transformer block immediately precedes the second transformer block; and generating, using a second self-attention sub-block of the second transformer block, the output features for the second transformer block based on the first attention propagation output and a value representation of the output for the third transformer block. One advantage of Clause 4 is that the second transformer may generate its own value representation, thereby improving model accuracy.

Clause 5: A method according to any of Clauses 1-4, wherein generating the first attention propagation output comprises generating, using the first transformer block, output features for the first transformer block by processing the attention matrix and a value representation of the input data for the first transformer block using the first self-attention sub-block. One advantage of Clause 5 is that the transformer can compute self-attention to improve model performance.

Clause 6: A method according to any of Clauses 1-5, wherein the first attention propagation output comprises the output features for the first transformer block. One advantage of Clause 6 is that the output features of the first transformer block can be re-used.

Clause 7: A method according to any of Clauses 1-6, further comprising generating, using the first transformer block, an output for the first transformer block, wherein generating the output for the first transformer block comprises processing output features of the first self-attention sub-block using a first feedforward sub-block of the first transformer block. One advantage of Clause 7 is that the first transformer block output can be used to improve or provide one or more predictions.

Clause 8: A method according to any of Clauses 1-7, wherein generating the output for the second transformer block comprises processing the output features of the second self-attention sub-block using a second feedforward sub-block of the second transformer block. One advantage of Clause 8 is that the second transformer block output can be used to improve or provide one or more predictions.

Clause 9: A method according to any of Clauses 1-8, wherein: the first transformer block comprises an encoder block, and the second transformer block comprises a decoder block. One advantage of Clause 9 is that the decoder may re-use attention from the encoder.

Clause 10: A method according to any of Clauses 1-9, wherein: the plurality of transformer blocks comprises a sequence of transformer blocks, the sequence of transformer blocks comprises one or more initial blocks, a plurality of intermediate blocks, and one or more final blocks, and the plurality of intermediate blocks comprises the first transformer block and the second transformer block. One advantage of Clause 10 is that attention can be shared between intermediate transformers in a sequence.

Clause 11: A method according to any of Clauses 1-10, wherein generating the first attention propagation output comprises processing the input data for the first transformer block using a plurality of window self-attention operations to generate the output features for the first transformer block. One advantage of Clause 11 is that a variety of self-attentions, such as window self-attention, can be used in conjunction with attention propagation.

Clause 12: A method according to any of Clauses 1-11, wherein the first attention propagation output comprises the output features for the first transformer block. One advantage of Clause 12 is that window self-attention features may be shared.

Clause 13: A method according to any of Clauses 1-12, wherein: propagating the first attention propagation output to the second transformer block comprises propagating the first attention propagation output using a propagation operation, the propagation operation comprises transforming the first attention propagation output by concatenating output features for a third transformer block of the plurality of transformer blocks to the first attention propagation output, and the third transformer block immediately precedes the second transformer block. One advantage of Clause 13 is that the propagation operation can include transforming the features to improve model performance.

Clause 14: A method according to any of Clauses 1-13, wherein: propagating the first attention propagation output to the second transformer block comprises propagating the first attention propagation output using a propagation operation, and the propagation operation comprises transforming the first attention propagation output using an upsampling operation. One advantage of Clause 14 is that the attention propagation can be upsampled to improve compatibility and model performance.

Clause 15: A method according to any of Clauses 1-14, wherein propagating the first attention propagation output to the second transformer block comprises propagating the first attention propagation output using a propagation operation. One advantage of Clause 15 is that the attention can be propagated using a variety of operations.

Clause 16: A method according to any of Clauses 1-15, wherein the propagation operation comprises transforming the first attention propagation output by performing one or more convolution operations on the first attention propagation output. One advantage of Clause 16 is that the convolution operations can improve model accuracy.

Clause 17: A method according to any of Clauses 1-16, wherein the propagation operation comprises an identity operation. One advantage of Clause 17 is that the attention can be propagated accurately and with reduced computational expense.

Clause 18: A method according to any of Clauses 1-17, wherein, when generating the output features for the second transformer block, the second self-attention sub-block does not compute an attention matrix. One advantage of Clause 18 is that computational expense and latency introduced by the second transformer block is reduced.

Clause 19: A processing system comprising: a memory comprising computer-executable instructions; and one or more processors configured to execute the computer-executable instructions and cause the processing system to perform a method in accordance with any of Clauses 1-18.

Clause 20: A processing system comprising means for performing a method in accordance with any of Clauses 1-18.

Clause 21: A non-transitory computer-readable medium comprising computer-executable instructions that, when executed by one or more processors of a processing system, cause the processing system to perform a method in accordance with any of Clauses 1-18.

Clause 22: A computer program product embodied on a computer-readable storage medium comprising code for performing a method in accordance with any of Clauses 1-18.

Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
generating, using a first transformer block of a plurality of transformer blocks, a first attention propagation output, the generating comprising processing input data for the first transformer block using a first self-attention sub-block of the first transformer block;
propagating the first attention propagation output to a second transformer block of the plurality of transformer blocks; and
generating an output for the second transformer block, the generating the output for the second transformer block comprising generating output features for the second transformer block based on the first attention propagation output.

2. The computer-implemented method of claim 1, wherein:
generating the first attention propagation output further comprises generating, using the first transformer block, an attention matrix; and
generating the attention matrix comprises processing a query representation and a key representation of the input data for the first transformer block using the first self-attention sub-block.

3. The computer-implemented method of claim 2, wherein the first attention propagation output comprises the attention matrix.

4. The computer-implemented method of claim 3, wherein generating the output features for the second transformer block further comprises:
accessing an output for a third transformer block of the plurality of transformer blocks, wherein the third transformer block immediately precedes the second transformer block; and
generating, using a second self-attention sub-block of the second transformer block, the output features for the second transformer block based on the first attention propagation output and a value representation of the output for the third transformer block.

5. The computer-implemented method of claim 2, wherein generating the first attention propagation output comprises generating, using the first transformer block, output features for the first transformer block by processing the attention matrix and a value representation of the input data for the first transformer block using the first self-attention sub-block.

6. The computer-implemented method of claim 5, wherein the first attention propagation output comprises the output features for the first transformer block.

7. The computer-implemented method of claim 1, further comprising generating, using the first transformer block, an output for the first transformer block, wherein generating the output for the first transformer block comprises processing output features of the first self-attention sub-block using a first feedforward sub-block of the first transformer block.

8. The computer-implemented method of claim 1, wherein generating the output for the second transformer block comprises processing the output features of the second self-attention sub-block using a second feedforward sub-block of the second transformer block.

9. The computer-implemented method of claim 1, wherein:
the first transformer block comprises an encoder block, and
the second transformer block comprises a decoder block.

10. The computer-implemented method of claim 1, wherein:
the plurality of transformer blocks comprises a sequence of transformer blocks,
the sequence of transformer blocks comprises one or more initial blocks, a plurality of intermediate blocks, and one or more final blocks, and
the plurality of intermediate blocks comprises the first transformer block and the second transformer block.

11. The computer-implemented method of claim 1, wherein generating the first attention propagation output comprises processing the input data for the first transformer block using a plurality of window self-attention operations to generate the output features for the first transformer block.

12. The computer-implemented method of claim 11, wherein the first attention propagation output comprises the output features for the first transformer block.

13. The computer-implemented method of claim 12, wherein:
propagating the first attention propagation output to the second transformer block comprises propagating the first attention propagation output using a propagation operation,
the propagation operation comprises transforming the first attention propagation output by concatenating output features for a third transformer block of the plurality of transformer blocks to the first attention propagation output, and
the third transformer block immediately precedes the second transformer block.

14. The computer-implemented method of claim 12, wherein:
propagating the first attention propagation output to the second transformer block comprises propagating the first attention propagation output using a propagation operation, and
the propagation operation comprises transforming the first attention propagation output using an upsampling operation.

15. The computer-implemented method of claim 1, wherein propagating the first attention propagation output to the second transformer block comprises propagating the first attention propagation output using a propagation operation.

16. The computer-implemented method of claim 15, wherein the propagation operation comprises transforming the first attention propagation output by performing one or more convolution operations on the first attention propagation output.

17. The computer-implemented method of claim 1, wherein, when generating the output features for the second transformer block, a second self-attention sub-block does not compute an attention matrix.

18. A processing system comprising:
a memory comprising computer-executable instructions; and
one or more processors configured to execute the computer-executable instructions and cause the processing system to perform an operation comprising:
generating, using a first transformer block of a plurality of transformer blocks, a first attention propagation output, the generating comprising processing input data for the first transformer block using a first self-attention sub-block of the first transformer block;
propagating the first attention propagation output to a second transformer block of the plurality of transformer blocks; and
generating an output for the second transformer block, the generating the output for the second transformer block comprising generating output features for the second transformer block based on the first attention propagation output.

19. The processing system of claim 18, wherein:
generating the first attention propagation output further comprises generating, using the first transformer block, an attention matrix; and
generating the attention matrix comprises processing a query representation and a key representation of the input data for the first transformer block using the first self-attention sub-block.

20. The processing system of claim 19, wherein the first attention propagation output comprises the attention matrix.

21. The processing system of claim 20, wherein generating the output features for the second transformer block further comprises:
accessing an output for a third transformer block of the plurality of transformer blocks, wherein the third transformer block immediately precedes the second transformer block; and
generating, using a second self-attention sub-block of the second transformer block, the output features for the second transformer block based on the first attention propagation output and a value representation of the output for the third transformer block.

22. The processing system of claim 19, wherein generating the first attention propagation output comprises generating, using the first transformer block, output features for the first transformer block by processing the attention matrix and a value representation of the input data for the first transformer block using the first self-attention sub-block.

23. The processing system of claim 22, wherein the first attention propagation output comprises the output features for the first transformer block.

24. The processing system of claim 18, the operation further comprising generating, using the first transformer block, an output for the first transformer block, wherein generating the output for the first transformer block comprises processing output features of the first self-attention sub-block using a first feedforward sub-block of the first transformer block.

25. The processing system of claim 18, wherein generating the output for the second transformer block comprises processing the output features of the second self-attention sub-block using a second feedforward sub-block of the second transformer block.

26. The processing system of claim 18, wherein:
the first transformer block comprises an encoder block, and
the second transformer block comprises a decoder block.

27. The processing system of claim 18, wherein:
the plurality of transformer blocks comprises a sequence of transformer blocks,
the sequence of transformer blocks comprises one or more initial blocks, a plurality of intermediate blocks, and one or more final blocks, and
the plurality of intermediate blocks comprises the first transformer block and the second transformer block.

28. The processing system of claim 18, wherein generating the first attention propagation output comprises processing the input data for the first transformer block using a plurality of window self-attention operations to generate the output features for the first transformer block.

29. The processing system of claim 28, wherein the first attention propagation output comprises the output features for the first transformer block.

30. The processing system of claim 29, wherein:
propagating the first attention propagation output to the second transformer block comprises propagating the first attention propagation output using a propagation operation,
the propagation operation comprises transforming the first attention propagation output by concatenating output features for a third transformer block of the plurality of transformer blocks to the first attention propagation output, and
the third transformer block immediately precedes the second transformer block.

31. The processing system of claim 29, wherein:
propagating the first attention propagation output to the second transformer block comprises propagating the first attention propagation output using a propagation operation, and
the propagation operation comprises transforming the first attention propagation output using an upsampling operation.

32. The processing system of claim 18, wherein propagating the first attention propagation output to the second transformer block comprises propagating the first attention propagation output using a propagation operation.

33. The processing system of claim 32, wherein the propagation operation comprises transforming the first attention propagation output by performing one or more convolution operations on the first attention propagation output.

34. The processing system of claim 18, wherein, when generating the output features for the second transformer block, a second self-attention sub-block does not compute an attention matrix.

35. A processing system, comprising:
means for generating, using a first transformer block of a plurality of transformer blocks, a first attention propagation output, the means for generating being configured to process input data for the first transformer block using a first self-attention sub-block of the first transformer block;
means for propagating the first attention propagation output to a second transformer block of the plurality of transformer blocks; and
means for generating an output for the second transformer block, the means for generating the output for the second transformer block being configured to output features for the second transformer block based on the first attention propagation output.
